(19) United States
(12) Patent Application Publication
(10) Pub. No.: US 2008/0181108 A1
(43) Pub. Date: Jul. 31, 2008

(54) Dynamic Feedback For Outbound Link Rate Adjustment In Multi-Rate Downstream

(75) Inventors: Shameem Hashmi, Carlsbad, CA (US); Aniruddha Das, San Diego, CA (US); David Jacob Rhodes, San Marcos, CA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 11/869,520

(22) Filed: Oct. 9, 2007

Related U.S. Application Data
(60) Provisional application No. 60/828,548, filed on Oct. 6, 2006.

(51) Int. Cl. H04L 12/26

(52) U.S. Cl. 370/231

(57) ABSTRACT

Systems and methods for regulating the throughput of a channel between a gateway and one or more subscriber terminals are disclosed. Various embodiments of the invention provide for monitoring link utilization between a gateway and a subscriber terminal at, for example, the physical layer of the OSI model. Based in part on the link utilization the link throughput may be throttled at a layer higher than, for example, the transport layer. Regulating may occur by advertising a decreased TCP window size or intelligently dropping packets. In another embodiment, a subscriber terminal may estimate the signal to noise ratio of a forward link channel and communicate this SNR to the gateway. The gateway may adjust the modulation and/or coding of the signal in response to the SNR. The gateway may also throttle deliver of packets in response to changes these changes in the modulation and/or coding of the signal.

### CROSS-REFERENCES TO RELATED APPLICATIONS

This application is a non-provisional, and claims the benefit, of commonly assigned U.S. Provisional Application No. 60/828,548, filed Oct. 6, 2006, entitled “Dynamic Feedback For Outbound Link Rate Adjustment In Multi-Rate Downstream,” the entirety of which is herein incorporated by reference for all purposes.

### BACKGROUND OF THE INVENTION

This disclosure relates in general to satellite communications and, but not by way of limitation, to dynamic wireless link rate adjustments amongst other things.

The quality of a satellite communication channel may vary over time. The signal to noise ratio (SNR) may vary depending on the atmospheric conditions. For example, the SNR may be high during cloudless periods and the SNR may be low during thunderstorms. The quality of the communication channel through the atmosphere, therefore, varies depending on such atmospheric phenomena.

Many satellite systems also provide downlink communication to multiple subscriber terminals using various multiplexing schemes. A popular choice is time division multiple access (TDMA). In TDMA each subscriber terminal or terminals is associated with a downlink sub-channel and each sub-channel is transmitted over the data link at a specific period of time for a specific period of time. Various other multiplexing schemes are also used.

Moreover, if a packet stream enters the gateway at a rate greater than what can be utilized over the sub-channels then data packets are often inelegantly discarded or dropped. That is, the packets are discarded or dropped without regard for the type of data included in the packets or the type of application transmitting the packets.

Accordingly, there is a need in the art for a satellite communication system that provides a forward link that is dynamically adjustable as the forward channel quality varies. Moreover, there is also a need in the art for a satellite communication system that provides dynamic packet throttling based on the type of application or data associated with the packets.

### BRIEF SUMMARY OF THE INVENTION

A method of regulating data flow in a wireless channel between a source to a destination using TCP packets is provided according to one embodiment of the invention. The method includes estimating the channel utilization of the wireless channel at the network, data link or physical layer and communicating the estimated channel utilization to the application layer. If the estimated downstream channel utilization is greater than a maximum channel utilization then the method advertises a decreased TCP window size to the source. A portion of the channel may include a wireless channel between a gateway and a subscriber terminal through a satellite.

A method for throttling the throughput of a wireless channel between a transmitter and one or more receivers is also provided according to another embodiment of the invention. The channel may include one or more sub-channels and each sub-channel may be associated with a distinct receiver. The method may include receiving one or more data packets from a source and transmitting the data packets to the receivers through the channel. Phase shift keying may be used to modulate the data within a sub-channel and the data may be transmitted with a fixed symbol rate. The receiver may estimate and then transmit the signal to noise ratio to the transmitter. The transmitter may then adjust the order of the symbol modulation and/or the robustness of the error correction for the sub-channel associated with the first receiver in response to the signal to noise ratio received from the first receiver. The input of data packets may also be throttled in response to the signal to noise ratio information. The transmitter may be a satellite gateway and the receivers may be subscriber terminals and the wireless channel operates through one or more satellites. The throttling may be a substantially lossless throttle. The packets may include TCP packets and the throttling may include decreasing the TCP window size.

The adjusting may include decreasing the order of the symbol modulation if the signal to noise ratio includes a signal to noise ratio that is below a minimum signal to noise ratio. The adjusting may include increasing the order of the symbol modulation if the signal to noise ratio includes a signal to noise ratio that is above a maximum signal to noise ratio. The adjusting may include increasing the robustness of the code rate if the signal to noise ratio includes a signal to noise ratio that is below a minimum signal to noise ratio. The adjusting may also include decreasing the robustness of the code rate if the signal to noise ratio includes a signal to noise ratio that is above a maximum signal to noise ratio.

A method for throttling the throughput of a wireless channel between a gateway and one or more subscriber terminals through a satellite is provided according to another embodiment of the invention. The method may occur at the gateway. The channel may include one or more sub-channels and each sub-channel may be associated with a distinct subscriber terminal. The method may include monitoring the link utilization of the channel at the physical layer and determining whether the link utilization is greater than a dynamic link utilization limit. The link utilization may then be communicated to a second layer that is either the transport layer or a layer higher than the transport layer within the OSI model. The link may then be throttled at the second layer. The data packets may include TCP packets and the throttling may include decreasing the TCP window size. The throttling may also include throttling based on the type of application or type of data. The gateway, satellite, subscriber terminal, or a third party may monitor the link utilization of the channel. The gateway may receive a plurality of data packets from a source and the throttling the link throughput comprises deleting one out of every N packets received from the source, where N is a positive integer and varies in part based on the link utilization. In another embodiment of the invention, the gateway receives a plurality of data packets from a source and based on the rate the packets are received and the magnitude of the channel, the gateway may throttle the input of data packets or the source in order to reduce packet loss.

Another method for regulating wireless channel flow is provided according to one embodiment of the invention. The method may include receiving a plurality of TCP packets from at least a first source and placing the plurality of TCP packets in a buffer. The TCP packets may then be transmitted from the buffer through at least one sub-channel of the communication channel. The channel utilization may then be measured or estimated at the network, data link or physical layer. It may then be determined whether the downstream channel utilization is greater than a maximum utilization limit based in part on the estimated channel utilization. The TCP window sizes may then be decreased by advertising TCP window size adjustment. The method may also include estimating or measuring the residual buffer capacity.

A wireless communication system comprising a gateway, a satellite and one or more subscriber terminals communicatively coupled through a communication channel is also disclosed according to one embodiment of the invention. The gateway may be configured to receive TCP packets from at least a first source and transmit the TCP packets to a specific subscriber terminal through a sub-channel of the channel. The gateway may be configured to measures the channel utilization. The gateway may be configured to advertise a decreased TCP window size to the first source in response to determining the channel utilization is above a channel utilization maximum. The gateway may also be configured to advertise an increased TCP window size to the first source in response to determining the channel utilization is below a channel utilization minimum.

A method for throttling the throughput of a channel between a gateway and one or more subscriber terminals through a satellite is provided according to one embodiment of the invention. The method may occur at the gateway and may work on channels that include one or more sub-channels associated with a distinct subscriber terminal. The method may include monitoring the link utilization of the channel at the physical layer at the gateway or the subscriber terminal, and determining whether the link utilization is greater than a dynamic link utilization limit. The link utilization may then be communicated to a second layer that is either the transport layer or a layer greater than the transport layer within the OSI model. The link throughput may then be intelligently throttled at this second layer. The throttling may vary the throughput based on the type of application or data. The higher layer may then choose to reduce the rate at which packets are sent and create a graceful and loss-less throttling. In addition, the gateway may receive a plurality of data packets from a source and then throttle the link throughput by any number of schemes.

A satellite communication system comprising a gateway with a performance enhancing proxy and one or more subscriber terminals communicatively coupled with the gateway is provided according to another embodiment of the invention. The subscriber terminals and the gateway are communicatively coupled through a satellite using a forward channel and a reverse channel. The gateway may be configured to receive data as a plurality of data packets, for example, TCP packets and send the data through the forward channel to subscriber terminals as data packets. The forward channel may include a plurality of sub-channels, each sub-channel may include data for a specific subscriber terminal, and the data may be transmitted within each sub-channel at a fixed symbol rate. A first subscriber terminal may estimate the signal to noise ratio (SNR) of the forward channel and communicate the SNR to the gateway through the return link. The gateway may be further configured to adjust the robustness of the symbol modulation and/or the error correction of the sub-channel associated with the first subscriber terminal. The performance enhancing proxy may be configured to determine the type of application providing the data packets and throttle the transmission of the packets based on the application type and depending on the estimation of the SNR ratio of the forward channel. The gateway may also be configured to advertise a decreased or increased TCP window size.

The gateway portion of the satellite communication system may be configured to increase the modulation order if the SNR information includes a SNR value that is above a minimum threshold SNR value or decrease modulation order if the SNR information includes an SNR value that is below a maximum threshold SNR value. The gateway may also be configured to increase the robustness of the code rate if the SNR information includes an SNR value that is below a minimum SNR value or decrease the robustness of the code rate if the SNR information includes a signal to noise ratio that is above a maximum signal to noise ratio. The performance enhancing proxy may throttle packet transmission by deleting one out of every N packets received, where N is a positive integer and may vary in part on robustness of the symbol modulation and/or the error correction of the sub-channel associated with the first subscriber terminal.

A method for throttling the throughput of a channel between a gateway and one or more subscriber terminals through a satellite is provided according to another embodiment of the invention. The method may occur at a gateway. The channel may include one or more sub-channels and each sub-channel may be associated with a distinct subscriber terminal. The gateway may transmit data to the subscriber terminals through the channel using phase shift keying to modulate the data within a sub-channel and the data is transmitted with a fixed symbol rate. The gateway may then receive SNR information from a first subscriber terminal and adjust the robustness of the symbol modulation and/or the error correction for the sub-channel associated with the first subscriber terminal in response to the SNR information received from the first subscriber terminal.

The method may increase the modulation order if the SNR information includes an SNR value that is above a minimum threshold SNR value or decrease modulation order if the SNR information includes an SNR value that is below a maximum threshold SNR value. The method may increase the robustness of the code rate if the SNR information includes a SNR value that is below a minimum SNR value or decrease the robustness of the code rate if the SNR information includes a SNR value that is above a maximum SNR value.

A method for regulating channel flow is disclosed according to another embodiment of the invention. The method may include receiving a plurality of data packets, wherein the plurality of data packets comprise a data set and buffering the plurality of data packets in a data packet buffer. These data packets may then be transmitted through a forward channel. The channel utilization of the forward channel may be estimated at the physical layer or the network layer. The method may then determine whether the forward channel utilization is greater than a maximum utilization limit based in part on the estimated channel utilization. The data type for the data being transmitted as data packets may be determined and one or more packets may be deleted from the buffer based on the data type. The method may also delete one out of every N packets from the buffer, where N is a positive integer and may vary in part with the forward channel utilization. In another embodiment of the invention, the method may advertise a decreased TCP window size in order to slow the rate packets are sent to the gateway. The method may also indicate to a higher layer to inform the sender to reduce the rate at which it is sending packets.

A method for regulating channel flow in a communication system that transmits a plurality of data packets that represent a data set is provided according to another embodiment of the invention. The method may include estimating forward channel utilization at the network, data link or physical layer and communicating the estimated forward channel utilization to the application layer. If the estimated forward channel utilization is greater than a maximum channel utilization then discarding packets according to an application specific scheme. The application specific scheme may include discarding one packet out of every N packets, where N is a positive integer and varies in part with the downstream channel utilization. The method may also indicate to a higher layer to inform the sender to reduce the rate at which it is sending packets. In another embodiment of the invention, the method may advertise a decreased TCP window size in order to slow the rate packets are sent to the gateway.

In one embodiment, one or more wireless communication links have dynamic limits on throughput. For example, the limits of the one or more wireless communication links can change with symbol rate, coding and/or modulation. The Internet may be coupled with the wireless communication links to deliver information wirelessly. A lossless point-to-point communication protocol is used to couple information between the Internet and the one or more wireless communication links, for example transmission control protocol (TCP) is but one lossless point-to-point protocol. Based upon current dynamic limits on throughput of one or more wireless communication links, the lossless point-to-point communication protocol is throttled at a point from one end point to the other end point. In one embodiment, one end point is in the gateway.

In another embodiment, the real-time usage of a dynamically changing forward channel is monitored to throttle the Performance Enhancing Proxy (PEP) accordingly. The capacity of the communications channel is dynamically changing by employing adaptive coding and modulation while keeping the symbol rate constant. Other embodiments could also modify symbol rate, adaptive coding and/or modulation. The overall maximum throughput changes depending on the distribution of users at various modulation/codepoints and their usage patterns, which changes due to fade patterns. Apart from fade, the overall maximum throughput changes due to the Equivalent Isotropically Radiated Power (EIRP) drop-off in a satellite beam, installer pointing errors and other reasons.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a block diagram of an exemplary satellite communications system configured according to various embodiments of the invention.

FIG. 2 is an embodiment of the forward or downstream channel from the gateway to the subscriber terminal is shown.

FIG. 3 shows a variable length superframe structure to send data on the downstream according to one embodiment of the invention.

FIG. 4 shows an embodiment showing portions of the gateway used for the downstream production are shown according to one embodiment of the invention.

FIG. 5 shows a state machine of various embodiments of the present invention.

FIG. 6 shows another block diagram of a satellite communication system according to another embodiment of the invention.

FIG. 7 shows a flowchart of a method for throttling packets at a gateway according to another embodiment of the present invention.

FIG. 8 shows a flowchart of a method for throttling link utilization at a PEP according to another embodiment of the invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

In one embodiment, the present disclosure provides for throttling link utilization within a gateway. Satellite systems that deliver Internet traffic often provide a communication channel over which data packets may be transmitted to a plurality of subscriber terminals within sub-channels. The gateway may include a performance enhancing proxy (PEP) that spoofs the origin server or computer that packets have arrived at the required destination. The PEP may then control delivery of the packets over the satellite channel. Due to bit rate variations through the channel, the PEP may also throttle delivery of packets. This throttling may occur at an OSI layer greater than the transport layer. For instance, the throttling may occur at the application layer, where application specific throttling may occur. This cross layer design permits communication between OSI layers to provide a more intelligent packet delivery control. The magnitude of the throttle may be based, in part, on the link utilization. The throttling may also depend on the data type. If the link utilization decreases the throttling may back off in order to deliver more packets.

For example, packets may be received at a buffer within the PEP where packets are held. If link utilization is, for example, greater than 97% of the capacity of the link, then packets may be throttled in order to avoid over extending the link and incurring proper degradation. The PEP may then eliminate packets based on the application or data type. For example, if the buffer holds packets of video signals, then the PEP may eliminate, for example, every 7th packet. Such throttling provides intelligent degradation of the data. If the link utilization drops below, for example, 82% of the link capacity, than the throttling may back off. The PEP may also employ loss-less throttling by indicating to the higher layer protocol of the need to throttle. For example, the PEP may reduce or completely close its TCP window size for the connection to the origin server, in response to which the origin server slows down, or stops sending more data.

In another embodiment, the present disclosure provides for systems and methods for an adaptive satellite channel. The signal to noise ratio of a satellite downlink sub-channel may vary due to atmospheric events, motion of the receiver and or location of the receiver. As the sub-channel quality decreases the satellite system may adaptively adjust the modulation and/or coding of the sub-channel in order to adapt to the changed channel. These changes may maintain a constant symbol rate but may decrease the bit rate of the sub-channel. For example, a channel may operate with a high order modulation such as 8PSK and low coding robustness such as 8/9. As the sub-channel quality decreases, the gateway may adjust the modulation to QPSK and/or adjust the coding to 3/4. Changes in the order of the modulation and/or the coding may lower the available data bit rate. Various other symbol modulation and coding schemes may also be used. Such adjustments may increase the link utilization as the rate at which the data arrives has not changed. The gateway, may therefore, intelligently throttle packet delivery in response to the bit rate changes.

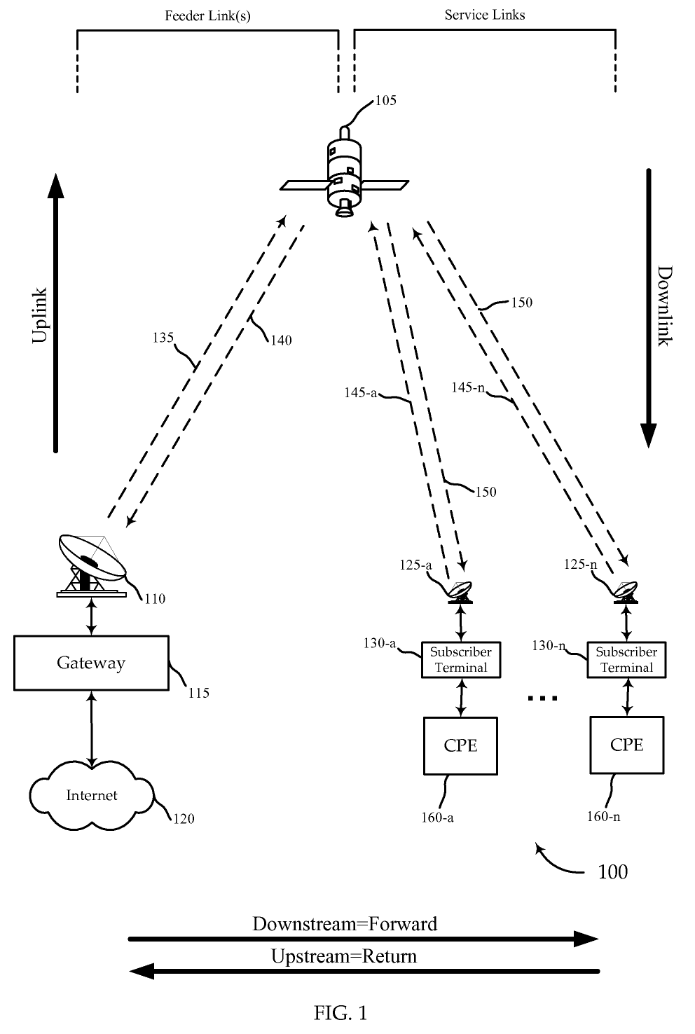

FIG. 1 is a block diagram of an exemplary satellite communications system 100 configured according to various embodiments of the invention. The satellite communications system 100 includes the Internet 120 interfaced with a gateway 115 that is configured to communicate with one or more subscriber terminals 130, via a satellite 105. A gateway 115 is sometimes referred to as a hub or ground station. Subscriber terminals 130 are sometimes called modems, satellite modems or user terminals. As noted above, although the communications system 100 is illustrated as a geostationary satellite 105 based communication system, it should be noted that various embodiments described herein are not limited to use in geostationary satellite based systems, for example some embodiments could be low-earth orbit (LEO) or medium-earth orbit (MEO) satellite based systems or even a terrestrial wireless communication system.

The network 120 may be any type of network and can include, for example, the Internet, an IP network, an intranet, a wide-area network (“WAN”), a local-area network (“LAN”), a virtual private network, the Public Switched Telephone Network (“PSTN”), and/or any other type of network supporting data and/or voice communication between devices described herein, in different embodiments. A network 120 may include both wired and wireless connections, including optical links. Many other examples are possible and apparent to those skilled in the art in light of this disclosure. As illustrated in a number of embodiments, the network may connect the gateway 115 with other gateways (not pictured), which are also in communication with the satellite 105.

The gateway 115 provides an interface between the network 120 and the satellite 105. The gateway 115 may be configured to receive data and information directed to one or more subscriber terminals 130, and can format the data and information for delivery to the respective destination device via the satellite 105. Similarly, the gateway 115 may be configured to receive signals from the satellite 105 (e.g., from one or more subscriber terminals) directed to a destination in the network 120, and can format the received signals for transmission along the network 120.

A device (not shown) connected to the Internet 120 may communicate with one or more consumer premises equipment (CPE) 160. Data and information, for example IP datagrams, may be sent from a device in the network 120 to the gateway 115. The gateway 115 may format a Medium Access Control (MAC) frame in accordance with a physical layer definition for transmission to the satellite 130. A variety of physical layer transmission modulation and coding techniques may be used with certain embodiments of the invention, including those defined with the DVB-S2 and WiMAX standards. The link 135 from the gateway 115 to the satellite 105 may be referred to hereinafter as the downstream uplink 135.

The gateway 115 may use an antenna 110 to transmit the signal to the satellite 105. In one embodiment, the antenna 110 comprises a parabolic reflector with high directivity in the direction of the satellite and low directivity in other directions. The antenna 110 may comprise a variety of alternative configurations and include operating features such as high isolation between orthogonal polarizations, high efficiency in the operational frequency bands, and low noise.

In one embodiment, a geostationary satellite 105 is configured to receive the signals from the location of antenna 110 and within the frequency band and specific polarization transmitted. The satellite 105 may, for example, use a reflector antenna, lens antenna, array antenna, active antenna, or other mechanism known in the art for reception of such signals. The satellite 105 may process the signals received from the gateway 115 and forward the signal from the gateway 115 containing the MAC frame to one or more subscriber terminals 130. In one embodiment, the satellite 105 operates in a multi-beam mode, transmitting a number of narrow beams each directed at a different region of the earth, allowing for frequency re-use. With such a multibeam satellite 105, there may be any number of different signal switching configurations on the satellite, allowing signals from a single gateway 115 to be switched between different spot beams. In one embodiment, the satellite 105 may be configured as a “bent pipe” satellite, wherein the satellite may frequency convert the received carrier signals before retransmitting these signals to their destination, but otherwise perform little or no other processing on the contents of the signals. A variety of physical layer transmission modulation and coding techniques may be used by the satellite 105 in accordance with certain embodiments of the invention, including those defined with the DVB-S2 and WiMAX standards. For other embodiments a number of configurations are possible (e.g., using LEO satellites, or using a mesh network instead of a star network), as evident to those skilled in the art.

The service signals transmitted from the satellite 105 may be received by one or more subscriber terminals 130, via the respective subscriber antenna 125. In one embodiment, the antenna 125 and terminal 130 together comprise a very small aperture terminal (VSAT), with the antenna 125 measuring approximately 0.6 meters in diameter and having approximately 2 watts of power. In other embodiments, a variety of other types of antennas 125 may be used at the subscriber terminal 130 to receive the signal from the satellite 105. The link 150 from the satellite 105 to the subscriber terminals 130 may be referred to hereinafter as the downstream downlink 150. Each of the subscriber terminals 130 may comprise a single user terminal or, alternatively, comprise a hub or router (not pictured) that is coupled to multiple user terminals. Each subscriber terminal 130 may be connected to CPE 160 comprising, for example computers, local area networks, Internet appliances, wireless networks, etc.

One embodiment of the system 100 exploits one or more geostationary spot-beam based satellites 105. These spot beams are a few hundred miles in diameter, and in one specific configuration, there are forty-five spot beams covering North America. Spot-beam based satellites allow frequency reuse amongst the different spot-beams leading to more efficient usage of spectrum, for example using a four color checkerboard pattern of coverage. However, even with these smaller spot-beams, the coverage of each spot-beam is large enough for various users within the same spot beam to have different ambient weather conditions. Ka-band satellites are known to be affected by atmospheric conditions such as absorption due to rain or clouds. Further, even under static weather conditions, the roll-off of satellite power from center to edge of beam coverage is one factor, e.g., users at beam edge have less power margin than users at beam center and thus, even without any fading, users at beam edge might be receiving data at a more robust operating point than those at beam center. The system 100 could also have users with different equipment (e.g. satellite dish), resulting in different received signal-to-noise ratios (SNR). Conventional satellite systems employing a static physical layer such as DVB-S account for a link margin that is sufficient to close the link to the user with the worst SNR, which leads to some inefficiencies as the link has unused margin for most of the users for most of the time.

In one embodiment, an adaptive physical satellite layer that can optimize throughput by dynamically adapting to each user's current link conditions. In the Adaptive Coding and Modulation (ACM) architecture of this embodiment, each user's link condition (SNR) is monitored continuously and if the link degrades due to a rain event or other atmospheric changes, the downstream modulation and/or code rate is changed to a more robust operating point. For example, in clear sky conditions, the user might be sent the downstream traffic at a highly efficient 8PSK-8/9 modulation and codepoint. However, the moment the link starts degrading, the codepoint/modulation would be changed from 8PSK-8/9 to progressively more robust ones, from 8PSK-5/6 down to the most robust codepoint supported, for example QPSK-1/2, resulting in about 10 dB of dynamic range. The overall symbol rate in the downstream is kept constant in this embodiment and depending on the link quality, the data intended for a specific user are transmitted at varying levels of efficiency/robustness. This ACM technique could be designed to work in conjunction with downlink power control at the satellite, leading to further increases in capacity. Other embodiments could vary the symbol rate.

Another embodiment increase the transmit power from the satellite or base station in response to fade. In another embodiment, a mobile satellite system is used where the user is mobile such that a satellite could get blocked (or partially blocked) due to shadowing by buildings, trees etc. Diversity techniques could be deployed to use multiple satellites where if one satellite is blocked but another is not, the data transmission could be switched over to this satellite. Any wireless system that can vary the channel bandwidth with lossless point-to-point protocols could be used in various embodiments.

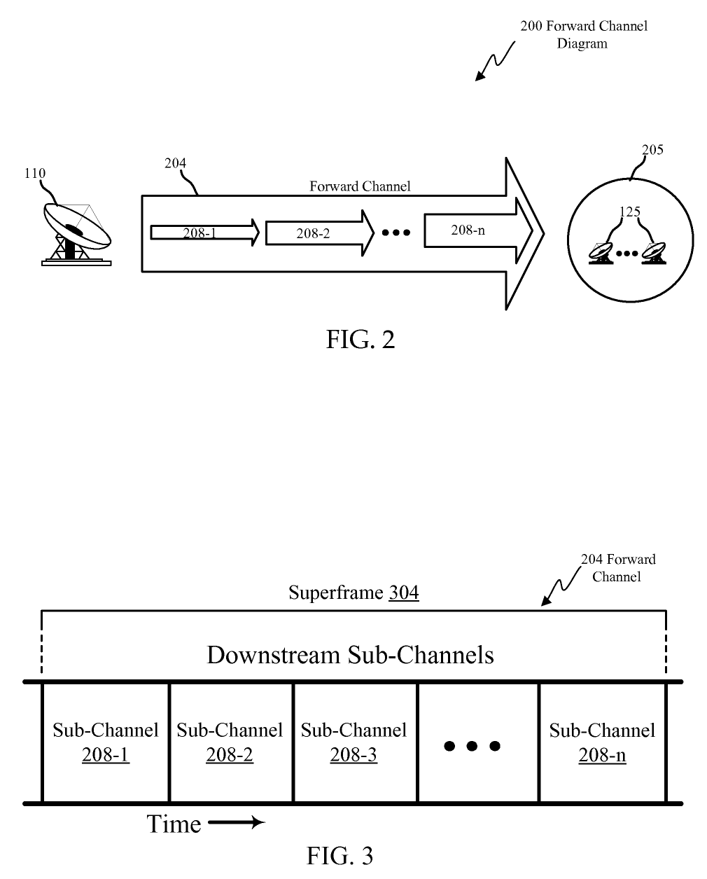

Referring next to FIG. 2, an embodiment of the forward or downstream channel 200 from the gateway 115 to the subscriber terminal 130 is shown. All subscriber terminals 130 within a spot beam 205 receive the forward channel 204. A fixed symbol rate channel is shared by the different subscriber terminals 130 in this embodiment. However, different consumers could be sent data at different modulation and codepoints depending on their operating signal to noise ratios. Each sub-channel or queue block 208 of the forward channel 204 is destined for a particular subscriber terminal 130 and is denoted by an arrow within the larger arrow of the forward channel 204. Arrows of different sizes convey the differences in coding and modulation that can be done for each sub-channel 208.

As shown in FIG. 3, the system 100 uses a variable length superframe 304 structure to send data on the downstream. Thus, each superframe 304 includes header and framing overhead (not shown) and data intended for different consumers such that every subscriber terminal 130 can receive its own sub-channel 208. In some embodiments, the size of the sub-channels 208 and superframe 304 can vary. For example, the superframe 304 might include two sub-channels 208 each of which contain data at QPSK-2/3 followed by a three sub-channels at 8PSK-8/9.

Although most of the ACM algorithm runs on the gateway hardware and software, it is initiated by each subscriber terminal 130 at the consumer premises in this embodiment. Each subscriber terminal estimates the downstream received SNR five times a second. An appropriately smoothed value of these SNR estimates is conveyed back to the headend via the periodic ranging messages that the subscriber terminal 130 sends back to the gateway 115. At the gateway 115, the SNR reported by each subscriber terminal 130 is compared to the switching thresholds (defined as SNR at which quasi-error free performance is attained for a particular modulation and code-point combination) for the various modulation/codepoints and if a threshold has been crossed, then a modulation/codepoint change process is initiated.

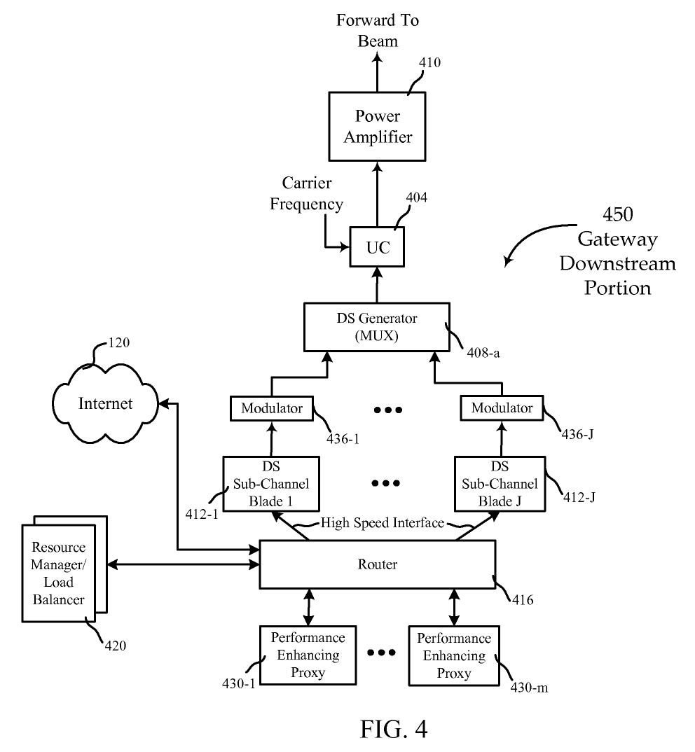

Referring next to FIG. 4, an embodiment showing portions 450 of the gateway 115 used for the downstream production are shown. A router 416 communicates with the Internet 120 to pass traffic from the satellite link. Requested content by subscriber terminals are gathered by the one or more performance enhancing proxies (PEPs) 430. Each PEP 430 services a number of sub-channels 208 that are all operating adaptively. This embodiment shows high-speed interfaces to J downstream (DS) sub-channels 412. Each DS sub-channel 412 is coupled to a modulator 436 that is programmed for the particular coding and modulation for a sub-channel 208.

Table I shows an example of how PEPs are assigned a number of sub-channels 208. The PEP 430 monitors the assigned modulators 436 to determine the current outbound link data rates for assigned sub-channels 208. This simple example shows two PEPs 430 with seven sub-channels 208. The first PEP 430-1 is assigned the first through fourth sub-channels 208-1 to 208-4, and the second PEP 430-2 is assigned the fifth through seventh sub-channels 208-5 to 208-7. Given current link conditions, the modulators assigned to the seven sub-channels 208 run at a few different speeds. All the time, the link conditions can vary. Table II shows different data rates for the sub-channels at a different time.

TABLE I
PEP Assignment to Sub-Channels

| PEP(s) | Sub-Channels | Data Rate |
|---|---|---|
| 430-1 | 208-1 | 40 Mbps |
| | 208-2 | 25 Mbps |
| | 208-3 | 10 Mbps |
| | 208-4 | 40 Mbps |
| 430-2 | 208-5 | 50 Mbps |
| | 208-6 | 25 Mbps |
| | 208-7 | 40 Mbps |

TABLE II
PEP Assignment to Sub-Channels

| PEP(s) | Sub-Channels | Data Rate |
|---|---|---|
| 430-1 | 208-1 | 25 Mbps |
| | 208-2 | 45 Mbps |
| | 208-3 | 50 Mbps |
| | 208-4 | 10 Mbps |
| 430-2 | 208-5 | 35 Mbps |
| | 208-6 | 45 Mbps |
| | 208-7 | 40 Mbps |

The PEPs 430 request content objects and controls the speed at which they are delivered. The PEP 430 serves to break the point-to-point connection that would normally go from a web server to the CPE 160 into two separate links. The PEP 430 spoofs the origin server into believing the origin server is in direct communication with the CPE 160, but the PEP 430 is actually the end point for the first link. The content is delivered to subscriber terminal 130, which performs a second spoof such that the CPE 160 believes it is directly communicating with the origin server, but is actually linked to the subscriber terminal 130 in a second link. In this way, the PEP 430 can accelerate lossless point-to-point protocols over high latency and lossy links. The speed of the link with the origin server can be controlled at the PEP itself, which is the endpoint for lossless point-to-point protocols (e.g., TCP) or controlled at some intermediate node, for example, the router 416. In any event, the PEP 430 or a similar device, using embodiments of the present invention, tracks the ever changing data rates for each sub-channel 208 to avoid overloading the available bandwidth. Some embodiments could vary the size of the sub-channel or use buffering to avoid packet loss for synchronization issues between the Internet links and the satellite links. Other embodiments may delete or remove packets based on the specific application transmitting the packets. In some embodiment, the PEP 430 also converts TCP to eXpress Transfer Protocol (XTP), which is used between the PEP 430 and the subscriber terminal 130.

The capacity of the channel may change for any reason, such as environmental factors, operational factors, etc. In some situations, in response to changes in the channel capacity, changes in channel utilization may be tolerated. This tolerance may depend on the duration and/or the magnitude of the change in channel utilization. For example, brief fluctuations in channel utilization caused by environmental effects may not necessitate changes in the packet flow. Of course, a maintained and/or substantial increase in channel utilization may motivate a decrease in packet flow. Similarly, a maintained and/or substantial decrease in channel utilization may motivate an increase in packet flow.

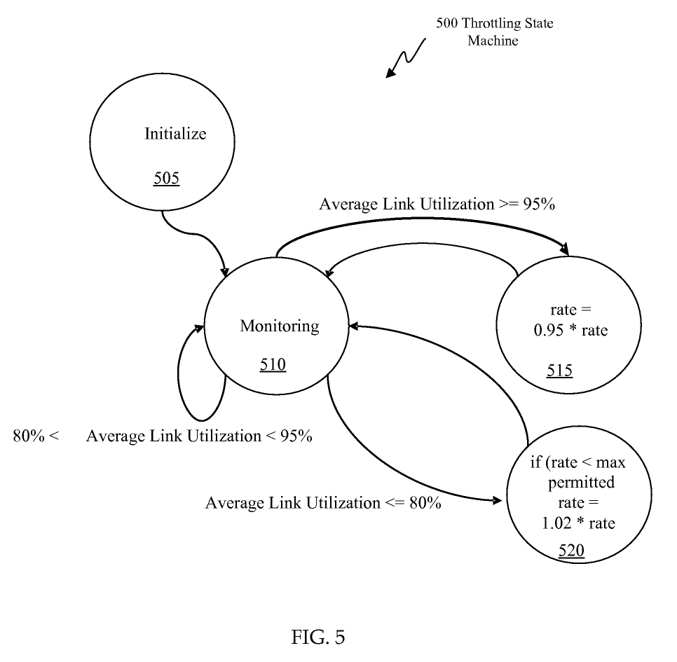

FIG. 5 shows a state machine of various embodiments of the present invention. The system is initialized at state 505. After initialization the system monitors the average link utilization at state 510. The average utilization allows for small level spikes up or down in the utilization. If the average link utilization increases past 95% of the capacity then we move to state 515 where the utilization is decreased by 95%. Once the utilization drops below 95% of capacity then it returns to the monitoring state 510. If the average link utilization drops below 80% then the system moves to state 520 where the link utilization may be increased by 2% until the utilization is back above 80%.

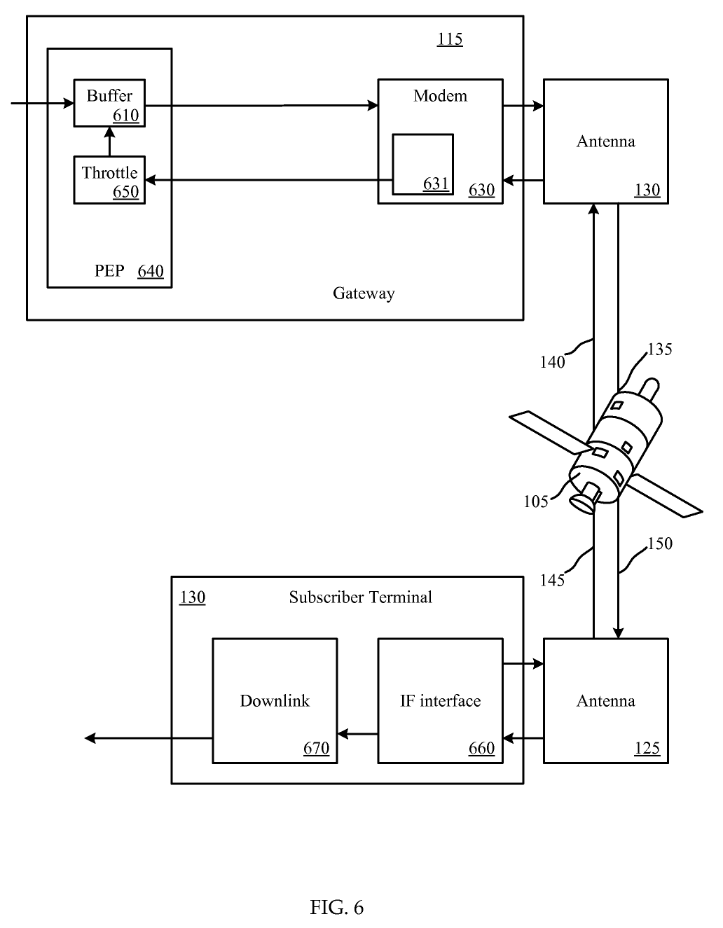

FIG. 6 shows another block diagram of a satellite communication system according to another embodiment of the invention. This embodiment shows some components of both the gateway 115 and the subscriber terminal 130. The subscriber terminal 130 may receive a plurality of packets from a specific gateway application or from a network as shown in FIG. 1. These packets may be placed within one or more buffers 610 within one or more PEPs 640. The PEP 640 may also include a throttle buffer 650 that controls the output of the buffered packets within the PEP. The throttle may also be termed a regulator. The gateway may also include a link utilization module 631. The link utilization module is configured to determine the utilization of the channel and communicate this information to the PEP. Of course, the PEP 640 may include various other components beyond the throttle and PEP and the monitor. The buffered packets are sent from the buffer 610 to the modem 630 according to a schedule dictated by the throttle 650. Various other components or blocks may lie between the PEP and the modem 630. The modem modulates the data packets into the proper modulation scheme, with the proper order of phase shift keying and/or the proper coding scheme. The order of the symbol modulation and the coding scheme may vary dynamically as will be shown below depending on channel conditions as measured from the subscriber terminal.

At the subscriber terminal 130 the IF interface 660 measures or estimates the signal to noise ratio (SNR) of the channel between the gateway 115 and the subscriber terminal 130. For example, the SNR is measured five times a second and averaged. This averaged SNR is transmitted back to the gateway 115. At the modem 630 the order of the symbol modulation may be adjusted in order to compensate for changes in the SNR. In another embodiment, at the modem 630 the coding scheme may also change in order to compensate for changes in the SNR. In yet another embodiment the order of the symbol modulation and/or the coding may both change. For example, the channel may have a very high SNR, therefore, the modem may transmit symbols at 8PSK with 8/9 coding. If the channel SNR changes, for example, due to atmospheric conditions, the order of the symbol modulation may be changed to QPSK or BPSK and the coding may be reduced to more robust coding, such as, 5/6, 3/4, 1/2, etc. If the SNR increases, then the order of the symbol modulation may increase and/or the coding may become less robust. While the modem 630 may continue to transmit symbols at a fixed symbol rate, the number of bits per symbol may change over time as the order of the symbol modulation is changed and/or the redundancy of the bits may also change over time.

While the SNR is low and the modem adjusts the modulation and/or coding the data rate is much lower and number of packets that can be transmitted to the subscriber terminal over the channel decreases. Accordingly, the channel utilization may be determined at the network, data link or physical layers at the modem, the subscriber terminal or another component of the gateway. The channel utilization may be communicated to the PEP 640 where the throttle 650 may gracefully limit the number of packets that are sent from the PEP buffer 610 to the modem. The throttle may implement any of a number of intelligent protocols to limit packet transmission. The throttle may limit packet transmission based on the type of application or packets that are being transmitted. This determination may occur at the application layer or a layer greater than the transport layer within the OSI model.

For example, if the data packets contain streaming video, the throttle may discard one packet out of every 10 packets in order to maintain data transmission. In such a case the video presentation at the user end may still provide video but with one out of ten frames missing. As another example, if a webpage, including plurality of images is being transmitted, the throttle may disregard one or more of the images allowing the other images and the webpage to be transmitted and loaded at the user's computer. The user's web browser may recognize that the images were not loaded and request the discarded images. Accordingly, the PEP 640 may intelligently throttle the transmission of packets from the PEP buffer 610. Various other methods or systems may be derived to provide throttled packet transmission based on the data or application sending the packets. The PEP may determine the nature of data or application by reading the headers of the data packets.

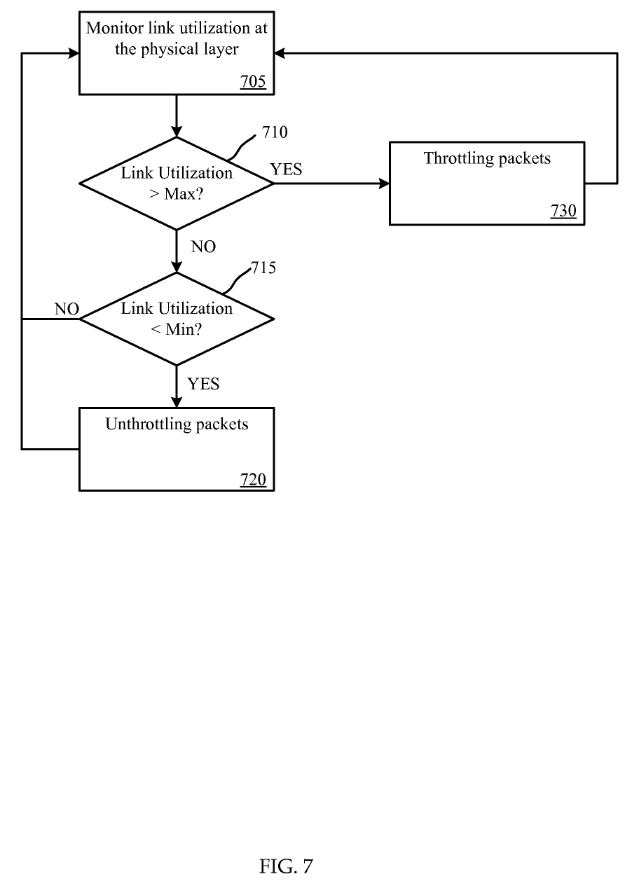

FIG. 7 shows a flowchart of a method for throttling packets at a gateway according to another embodiment of the present invention. According to this embodiment of the invention, intra layer communication occurs within the various OSI layers to provide an intelligent data rate or intelligently adjust the data rate. The gateway may monitor the link utilization at the physical layer at block 705. This monitoring may also occur at other layers such as the transport and/or the data link layers. Moreover the monitoring may occur at each of a plurality of communication sub-channels. The monitoring may monitor the number of bits being transmitted over time and the instantaneously available bandwidth to determine utilization. The monitoring may also monitor the depth of various queues in modem 630 to determine that the data is backing up and the utilization must be high.

If the link utilization is greater than a maximum set value as determined at block 710 then the packets may be intelligently throttled at the application layer at block 730. The link utilization may have increased above the maximum value because the robustness of the coding decrease or the modulation order increased and therefore decreasing the bit rate of the channel. For example, if the link utilization increases beyond 95% of link capacity then the PEP adaptively decreases packet throughput in order to keep the link utilization in check.

If, however, the link utilization is below the max and the link utilization is not less than a minimum value as determine at block 715 the system continues to monitor the physical layer. If the link utilization is less than a minimum value as determined at block 720, then packet throttling, if it is occurring, stops or decreases at block 720. For example, if the average link utilization is less than 80% then the PEP adaptively increases packet throughput in order to increase utilization of the channel. The link utilization may decrease, for example, when SNR of the channel permits decreased keying and coding robustness. The link utilization may increase or decrease for any of a number of parameters.

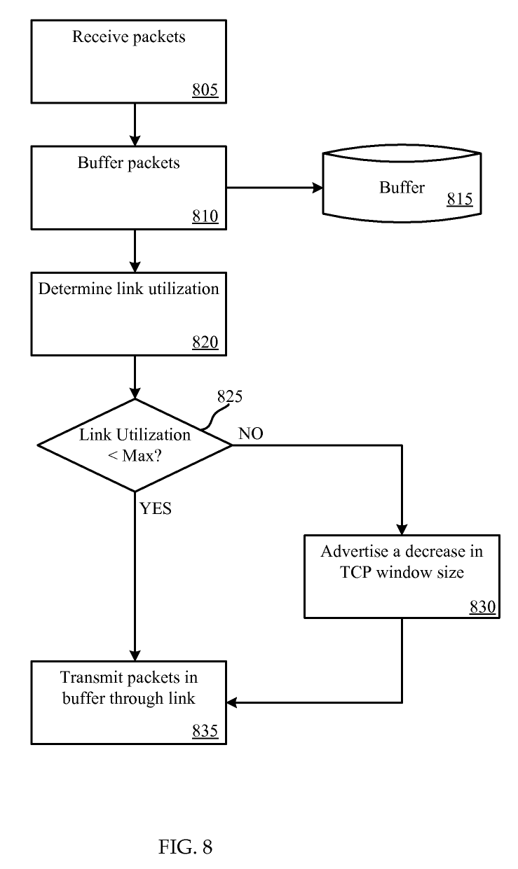

FIG. 8 shows a flowchart of a method for throttling link utilization at a PEP according to another embodiment of the invention. Packets are received at the PEP at block 805. The packets may then be placed in a buffer 815 at block 810. The link utilization may then be determined at block 820. Determining the link utilization may occur prior to and during reception of the packets. If the buffer is empty and there is sufficient link utilization then the packets may be transmitted through at least the throttling portion of a PEP. If the link utilization is less than the maximum allowable link utilization, as determine at block 825, then packets are transmitted from the buffer in a first in first out format. Otherwise, as part of throttling, it the link utilization is not less than the maximum allowable link utilization, as determined at block 825, then the system advertises to the sender that the TCP window size is reduced at block 830. According to the TCP protocol, the sender should slow down the rate at which they send packets. Regardless, packets in the buffer are transmitted though the link at block 835. In this case the maximum link utilization threshold would be such that the data already present in the buffer can be handled by the link and would serve as an early indicator of imminent congestion. Slowing the sender prevents congestion from occurring.

Various other throttling techniques may be used. For example, packets may be intelligently dropped or delayed. The number, frequency, and arrangement of packets being removed may depend on the application or data types. For example, every tenth packet may be removed from the buffer for packets containing streaming video. As another example, packets containing an image may be removed from the buffer in bulk.

Many of the various embodiments of the invention refer to satellite communication systems. The embodiments of the invention, however, are not limited solely to satellite communication systems. Satellite communication systems are mentioned solely as an example of a wireless system within which embodiments of the invention may apply. Various wireless systems may also employ embodiment of the invention, for example, wireless internet such as WiFi and/or wireless broadband handheld systems.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method of regulating data flow in a wireless channel between a source and a destination, wherein the data is transmitted using data packets, the method comprising:
estimating the channel utilization of the wireless channel at a first layer, wherein the first layer is selected from the layers within the OSI reference model consisting of: the network layer, the data link layer, and the physical layer;
communicating the estimated channel utilization to a second layer, wherein the second layer is higher than the first layer within the OSI reference model;
determining whether the estimated channel utilization is greater than a percentage of the channel capacity; and
regulating the flow of data packets if the channel utilization is greater than a percentage of the channel capacity.

2. The method according to claim 1, wherein the regulating comprises decreasing the TCP window size.

3. The method according to claim 1, wherein the regulating comprises randomly dropping packets.

4. The method according to claim 1, wherein the regulating comprises application aware packet dropping.

5. The method according to claim 1, wherein the regulating comprises deleting one out of every N packets received, where N is a positive integer and varies in part based on the link utilization.

6. The method according to claim 1, further comprising:
determining whether the estimated channel utilization is less than a percentage of the channel capacity; and
if the channel utilization is less than a percentage of the channel capacity, then regulating the flow of data packets.

7. A method for regulating the throughput of a wireless channel between a transmitter and one or more receivers, wherein the channel includes one or more sub-channels and each sub-channel is associated with one or more receivers, the method comprising:
transmitting data packets to at least a first receiver over a first sub-channel;
adjusting the capacity of the first sub-channel in response to a change in the sub-channel;
estimating the channel utilization of the first sub-channel at a first layer, wherein the first layer is selected from the layers within the OSI reference model consisting of: the network layer, the data link layer, and the physical layer;
communicating the estimated channel utilization to a second layer, wherein the second layer is higher than the first layer within the OSI reference model;
determining whether the first sub-channel estimated channel utilization is greater than a percentage of the channel capacity; and
regulating the flow of data packets if the channel utilization is greater than a percentage of the channel capacity.

8. The method according to claim 7, wherein the transmitter comprises a gateway that transmits data to a receiver through a satellite.

9. The method according to claim 7, wherein the regulating comprises randomly dropping packets.

10. The method according to claim 7, wherein the regulating comprises application aware packet dropping.

11. The method according to claim 7, wherein the data packets comprise TCP packets and the regulating includes decreasing the TCP window size.

12. A method for regulating wireless channel flow, the method comprising:
receiving a plurality of TCP packets from at least a first source;
placing the plurality of TCP packets in a buffer;
transmitting the TCP packets from the buffer through a first sub-channel of a communication channel to at least one receiver;
estimating the channel utilization of the first sub-channel at the network, data link or physical layer;
determining whether the estimated channel utilization is greater than a percentage of the channel capacity; and
if the channel utilization is greater than a percentage of the channel capacity, then advertising a decreased the TCP window size to the source.

13. The method according to claim 12, wherein estimating the channel utilization includes determining the residual buffer capacity.

14. A wireless communication system comprising a gateway, a satellite and one or more subscriber terminals communicatively coupled through a wireless communication channel that includes one or more sub-channels, wherein:
the gateway is configured to receive TCP packets from at least a first source and transmit the packets using a second communication protocol to at least one subscriber terminal through a first sub-channel, measures the channel utilization, and advertise a decreased TCP window size to the first source in response to determining the channel utilization is above a percentage of channel capacity.

15. The method according to claim 14, wherein the gateway is configured to advertise an increased TCP window size to the first source in response to determining the channel utilization is below a channel utilization minimum.

16. The method according to claim 14, where the gateway transmits packets to the subscriber terminals through a satellite.

17. A wireless communication system comprising
a modem wirelessly coupled with one or more subscriber terminals through one or more sub-channels, wherein the modem is configured to adaptively adjust either or both of the order of the symbol modulation or the robustness of the coding in a sub-channel in response to a change in the signal to noise ratio of the sub-channel and the modem is configured to estimate the channel utilization at a first layer within the OSI reference model consisting of: the network layer, the data link layer, and the physical layer; and
a network agent coupled with the modem and a computer network, wherein the network agent receives data packets from the computer network and forwards the data packets to the modem for transmission to one or more of the subscriber terminals, the network agent is configured receive a channel utilization estimate from the modem at a layer greater than the first layer and if the channel utilization estimate is greater than a percentage of the channel capacity then the network agent regulates packet flow to the modem.

18. The wireless communication system according to claim 17, wherein the modem and network agent are included within a gateway and the gateway communicates with the one or more subscriber terminals through a satellite.

19. The wireless communication system according to claim 17, wherein the data packets are TCP packets and the network agent regulates packet flow by advertising a lower TCP window size.

20. The wireless communication system according to claim 17, wherein the network agent regulates packet flow by dropping every N packets.

21. The wireless communication system according to claim 17, wherein the network agent regulates packet flow by dropping packets in accordance with an application specific protocol.

22. The method according to claim 14, where the gateway transmits packets to the subscriber terminals through a satellite.
